(19) United States
(12) Patent Application Publication
(10) Pub. No.: US 2015/0162573 A1
(43) Pub. Date: Jun. 11, 2015

(54) BEVELED CELL DESIGN FOR AN ALKALINE BATTERY

(71) Applicant: Encell Technology, Inc., Alachua, FL (US)

(72) Inventors: Randy Gene OGG, Newberry, FL (US); Michael MEESE, Gainesville, FL (US); Phil BENNETT, Waldo, FL (US); Keith Bryan SMITH, Newberry, FL (US); Michael RODERS, Gainesville, FL (US); Elizabeth MARTIN, O'Brien, FL (US)

(73) Assignee: ENCELL TECHNOLOGY, INC., Alachua, FL (US)

(21) Appl. No.: 14/566,439

(22) Filed: Dec. 10, 2014

Related U.S. Application Data
(60) Provisional application No. 61/914,068, filed on Dec. 10, 2013.
(60) Provisional application No. 61/914,069, filed on Dec. 10, 2013.

(51) Int. Cl. H01M 2/02; H01M 10/26; H01M 4/66; H01M 4/62; H01M 4/80; H01M 10/24; H01M 4/24

(52) U.S. Cl. CPC H01M 2/02; H01M 10/24; H01M 10/26; H01M 4/248; H01M 4/244; H01M 4/622; H01M 4/808; H01M 4/661

(57) ABSTRACT

Provided is an alkaline battery comprising at least one positive electrode and at least one negative electrode with a separator disposed there between, which are contained in a cell casing that applies greater pressure to the electrodes toward the bottom of the electrode stack and less pressure towards the top of the electrode stack. In one embodiment, the battery comprises a positive nickel electrode and a negative iron electrode.

### RELATED APPLICATIONS

The present application claims priority to U.S. provisional application 61/914,069, filed Dec. 10, 2013 and U.S. provisional application 61/914,068, filed Dec. 10, 2013, the contents of which applications are herein incorporated by reference in their entirety.

### FIELD OF INVENTION

The present invention is in the technical field of energy storage devices. More particularly, the present invention is in the technical field of rechargeable batteries using an alkaline electrolyte, and having a particular cell design.

### STATE OF THE ART

Batteries with an alkaline electrolyte have been known for over a hundred years. Most of these batteries are based on the use of a nickel oxide active material as the cathode paired with a various metals or metal-hydrides as the anode. A number of types of cell construction are possible for each of these batteries. These variations in cell construction lie mostly in the nature of electrode support utilized. For the positive electrode three principal types are recognized—pocket plate, sintered plate and foam-based plates. An electrode support is necessary because the active material (nickel hydroxide) is a solid and held in pockets in the pocket-plate-design, held in the pores of the sintered plate design, or mixed with gel or paste and placed in foam-based plate electrodes. Also, cobalt, cobalt hydroxide, zinc hydroxide, cadmium hydroxide, yttrium hydroxide, and/or other metal hydroxides need to be added to improve the conductivity of nickel hydroxide.

Negative electrode designs make use of an even broader range of materials including pocket plates, sintered nickel powder, fiber, foam and plastic bonded supports. It is the physical stability of the active material in the negative electrode that permits such a wide variety of support materials. Nickel hydroxide in the positive electrode, however, swells appreciably during charge and discharge, straining the support and restricting the choice of support type at the positive electrode.

Nickel-iron (Ni—Fe) batteries have been known for over a hundred years. These batteries are based on the use of a nickel oxide active material as the cathode paired with an iron electrode as the anode with an alkaline electrolyte. These batteries are known for their long cycle and calendar life, tolerance to electrical abuse such as overcharge and overdischarge, and overall physical ruggedness. These batteries however, do have disadvantages such as poor charge retention, poor low temperature performance, and low power density.

Commercially available Ni—Fe cells currently contain a thick spacer or mesh-like material between each electrode. The large distance between electrodes which is enforced by the thick spacer has a negative impact on the power performance in the cell as the internal resistance of the cell increases with electrode spacing. A larger electrode spacing also lowers the energy density of the cell.

In all cell construction types, a separator is placed between the two electrodes to prevent short circuits. There is a variety of separator materials and separator designs that may be used in these batteries. The function of the separator is to prevent electrical contact between the anode (negative electrode) and cathode (positive electrode) while providing minimal electrolyte (ionic) resistance. The design of the separator may be a non-woven sheet or felt, cloth, microporous fabric, a grid-like mesh inlay, or take the form of a spacer with an open area between the cathode and anode.

The separators used in the cell construction depends upon the types of electrodes used. In cells with a pocket plate electrodes, the anode and cathode are kept electrically isolated using a spacer or a grid-like mesh inlay and are typically held in a rigid frame. The open space between the electrodes allows for hydrogen and oxygen gas to diffuse away from the electrode and out of the electrolyte where it will not interfere with ionic transport and the electrochemical reactions at the electrode-electrolyte interface. However, the construction of these cells is more expensive as the electrode design is not amenable to lower-cost manufacturing methods. Furthermore, the large interelectrode spacing of these batteries imposed by the rigid support limits high rate performance as it increases electrolyte (ionic) resistance.

Cells with thin separators such as nonwoven polyolefin separators would allow for improved performance and higher energy density for Ni—Fe batteries compared to batteries with thicker spacers. With thin separators, there is intimate contact between the separator and the electrodes as the electrode stack is fairly tight. This lowers the internal resistance of the cell and allows higher charge and discharge rates to be realized. The overall fit of the electrode stack inside the cell case is fairly tight and the pressure applied to the electrode stack is uniform. However, in providing intimate contact between the separator and the electrode surface, the relatively small pore structure and tortuous nature of these separators can trap gas generated at the electrode surface. Such trapped gas can interfere with ionic transport and electrochemical reactions at the electrode surface and adversely affect battery performance.

Gas can be generated on the surface of both the iron and nickel electrodes via electrolysis of water. The generation of gas is especially significant in some alkaline batteries such as Ni—Fe batteries where the electrochemical potential for the reduction of water is actually more positive (i.e. more favored thermodynamically) than the reduction of Fe(OH)₂ to iron metal which recharges the anode as shown in Equation 2. The electrochemical potential for the oxidation of water, Equation 3, is also more positive than the reaction at the cathode during charge, Equation 4. Both electrodes are thermodynamically unstable in their charged state. Ultimately, this leads to significant gas generation during charging and during self-discharge.

2 H₂O+2 e⁻→H₂+2 OH⁻E^{O}=−0.828 V 1

Fe(OH)₂+2 e⁻→Fe+2 OH⁻E^{O}=−0.877 V 2

4OH⁻(aq)→O₂(g)+2H₂O(l)+4e⁻E^{O}=−0.40 V 3

Ni(OH)₂+OH⁻ [symbol] NiOOH+H₂O+e⁻E^{O}=−0.52 V 4

Gas generation in these cells, which occurs from the electrochemical oxidation and reduction of the electrolyte, is generally not regarded as a problem with regard to its effect on battery performance in cells with large electrode spacing as in the case with cells of the pocket plate design that use spacers or grid-like inlays to enforce separation of the anode and cathode. This is because the large space between electrodes allow gas to flow out of the cell. However, gas generation is a disadvantage in Ni—Fe batteries with small electrode spacing, as in cells with polyolefin separators. In this situation, the gas generated in the cell has a difficult time escaping and is trapped between the electrodes. Such trapped gas can interfere with ionic transport and electrochemical reactions at electrode surfaces and adversely affect battery performance.

It is therefore desirable to have a cell design utilizing separators that allows improved rate performance and energy densities but also allows gas to escape from between the electrodes. Such a design would be welcome to the industry. Therefore, an object of this invention is to provide such a cell design that allows gas to more easily escape from alkaline cells, e.g., Ni—Fe cells, to achieve improved charge and discharge performance as well as higher energy density.

### SUMMARY OF THE INVENTION

Provided is an alkaline battery comprising at least one positive electrode and at least one negative electrode with a separator disposed there between, which are contained in a cell casing that applies greater pressure to the electrodes towards the bottom of the electrode stack and less pressure towards the top of the electrode stack. In one embodiment, the battery is a Ni—Fe battery comprising at least one positive nickel electrode and at least one negative iron electrode. In one embodiment, the battery comprises a NaOH electrolyte also containing LiOH and an alkali metal sulfide.

Among other factors, it has been discovered that when an alkaline battery, and in particular a Ni—Fe battery, is used in which the cell case is beveled, i.e., the walls of the cell diverge outwardly so that the top of the cell is wider than the bottom of the cell, improved capacity is achieved. Higher capacity is particularly achieved at higher discharge currents. The design of the cell results in greater pressure being applied to the electrode stack at the bottom of the cell, and less pressure at the top of the electrode stack. This allows the gas to bubble out of the electrolyte and leave the electrode stack, and the cell. The gas no longer interferes with the electrochemical processes of the cell.

### BRIEF DESCRIPTION OF THE DRAWINGS

FIG. 1 is a drawing of a cell case that has two interior cell walls that are angled such that the distance between them is slightly larger at the top of the case than at the bottom. The face of these walls are facing the face of the electrodes.

FIG. 2 is a perspective view of a coated iron electrode.

FIG. 3 is a side view and cross-section view of an iron electrode coated on both sides of the substrate.

FIG. 4 is a plot of cell capacity versus cycle number for Ni—Fe cells with and without a beveled case design. The solid lines represent the cells of the present invention with a beveled case. The dashed lines represent cells without a beveled design where the pressure is applied evenly across the electrode stack.

### DETAILED DESCRIPTION OF THE INVENTION

The present invention provides a cell design that allows gas to more easily escape from between the electrodes in an alkaline battery, e.g., a Ni—Fe battery or Mn—Zn battery that uses separators, e.g., microporous separators. The invention provides structure by which the advantages of higher charge and discharge rates and higher energy density may be achieved for alkaline batteries while reducing or avoiding trapped gases that interfere with electrochemical reactions at the electrode surface which degrade cell performance.

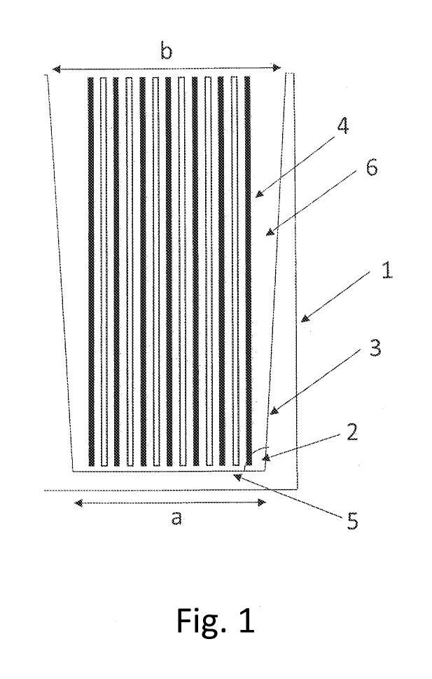

The cell design of the present invention creates a pressure gradient on the electrode stack that directs the gas out of the electrode stack. The pressure gradient is enforced on the electrode stack by the cell case design where some regions of the electrode stack are under greater pressure than other areas. Gas that forms between the electrodes flows from areas of high pressure to areas of lower pressure. The cell is designed so that the gradient directs the gas to the outside of the electrode stack where it no longer interferes with electrochemical processes and is able to bubble out of the electrolyte and leave the cell. The cell comprises a case that applies greater pressure to the electrodes towards the bottom of the electrode stack and less pressure towards the top of the electrode stack. This can be seen more clearly in reference to FIG. 1.

FIG. 1 shows a side view of the cell case 1. The angle 2 formed between the cell wall 3 that faces the face of the electrode stack 4 and the bottom of the cell case 5 is greater than 90°. This creates a larger gap 6 between the electrode stack towards the top of cell case than at the bottom. Because the electrode stack is tight fitting in the cell case, the larger gap at the top than at the bottom creates a pressure gradient along the electrode stack with greater pressure at the bottom. This greater pressure forces gas that is generated to migrate towards the top of the cell and out of the electrode stack. Once gas escapes from the top of the electrode stack it no longer interferes with electrochemical processes and the gas is able to leave the cell. The cell case may have a cover which is not shown in FIG. 1.

The battery may be prepared by conventional processing and construction. The electrodes can be sintered or a coated single substrate electrode. The electrodes of the present invention are generally single layer substrates, e.g., sintered or a coated single substrate electrode.

In one embodiment, a nickel oxyhydroxide positive electrode, an alkaline electrolyte, and an iron electrode are employed. The nickel electrode may be of a sintered type well known in the art or may be of a pasted type employing a foam or felt matrix. The iron electrode may be of a sintered type well known in the art or may be of a pasted type employing a foam or comprised of a single layer of conductive substrate coated with iron active material on one or both sides.

A preferred negative electrode is a pasted iron electrode. In the electrode, a single layer of substrate is used. This single layer acts as a carrier with coated material bonded to at least one side. In one embodiment, both sides of the substrate are coated. This substrate may be a thin conductive material such as a metal foil or sheet, metal foam, metal mesh, woven metal, or expanded metal. For example, 0.004 inch thick perforated nickel plated steel has been used, or a metal foam.

In one embodiment, the invention comprises a battery with an iron anode. The battery can be any battery with an iron electrode, such as a Ni—Fe or Mn—Fe battery. In one embodiment, the battery is a Ni—Fe battery. The battery, in one embodiment comprises an iron electrode comprised of a single, coated conductive substrate, prepared by a simple coating process, which can be continuous. The substrate can be coated on one side, or on both sides.

The coating mix for the iron electrode is a combination of binder and active materials in aqueous or organic solution. The mix can also contain other additives such as pore formers. Pore formers are often used to insure sufficient H₂ movement in the electrode. Without sufficient H₂ diffusion, the capacity of the battery will be adversely affected. The binder materials have properties that provide adhesion and bonding between the active material particles, both to themselves and to the substrate current carrier. The binder is generally resistant to degradation due to aging, temperature, and caustic environment. The binder can comprise polymers, alcohols, rubbers, and other materials, such as an advanced latex formulation that has been proven effective. A polyvinyl alcohol (PVA) binder is used in one embodiment. Advantageously, in one embodiment, the PVA binder is present in an amount ranging from 2.5 to 4 wt. % of the iron anode coating mix. Use of a binder to mechanically adhere the active material to the supporting single substrate eliminates the need for expensive sintering or electrochemical post-treatment. Aqueous based solutions have the advantage of lower toxicity and removal of water during the drying process is environmentally friendly and does not require further treatment or capture of the solvent.

The active material for the mix formulation can be selected from iron species that can be reversibly oxidized and reduced. Such materials include metal Fe and iron oxide materials. The iron oxide material will convert to iron metal when a charge is applied. Suitable iron oxide materials include Fe₃O₄ and Fe₂O₃. In addition, any other additives may be added to the mix formulation. These additives include but are not limited to sulfur, antimony, selenium, and tellurium. In one embodiment, the mix and therefore the iron electrode comprises a polyvinyl alcohol binder in combination with a sulfur additive. The sulfur additive can be elemental sulfur.

Sulfur as an additive has been found to be useful in concentrations ranging from 0.25 to 1.5%, and higher concentrations may improve performance even more. The combination of the sulfur additive with a polyvinyl alcohol binder has been found to provide particular advantages in an iron electrode. Nickel has been used as a conductivity improver and concentrations ranging from 8 to 20% have been found to improve performance, and higher concentrations may improve performance even more.

The coating method for producing the iron electrode can be a continuous process that applies the active material mixture to the substrate, such as spraying, dip and wipe, extrusion, low pressure coating die, or surface transfer. A batch process may also be used, but a continuous process is advantageous regarding cost and processing. The coating method must maintain a high consistency for weight, thickness, and coating uniformity. This insures that finished electrodes will have similar loadings of active material to provide uniform capacity in the finished battery product.

The coating method of the iron electrode employed is conducive to layering of various materials and providing layers of different properties, such as porosities, densities, and thicknesses. For example, the substrate can be coated with three layers; the first layer being of high density, second layer of medium density, and final layer of a lower density to create a density gradient. This gradient improves the flow of gases from the active material to the electrolyte and provides better electrolyte contact and ionic diffusion with the active material throughout the structure of the electrode.

The iron electrode employed in the invention may include continuous in-line surface treatments. The treatments can apply sulfur, polymer, metal spray, surface laminate, etc. In one embodiment, a polymer post-coat is applied.

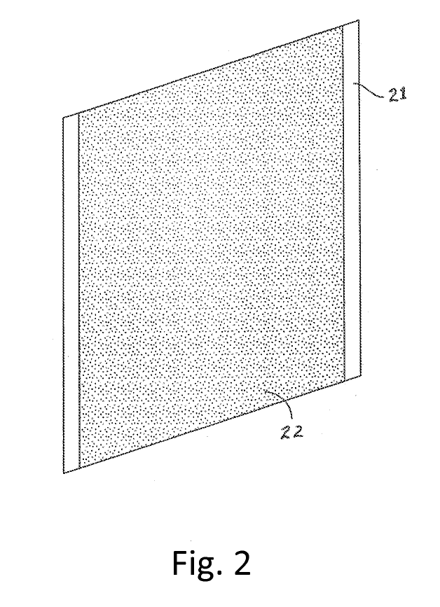

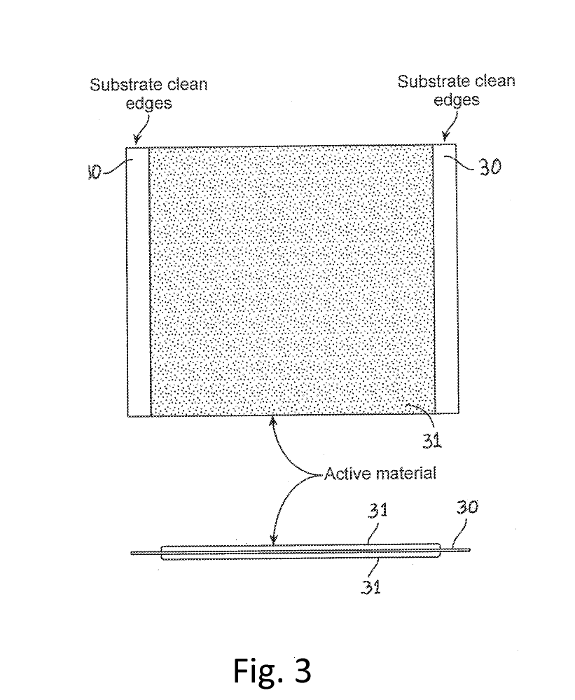

FIG. 2 is a prospective view of a coated iron electrode. The substrate 21 is coated on each side with the coating 22 comprising the iron active material and binder. This is further shown in FIG. 3. The substrate 30 is coated on each side with the coating 31 of the iron active material and binder. The substrate may be coated continuously across the surface of the substrate, or preferably, as shown in FIGS. 2 and 3, cleared lanes of substrate may be uncoated to simplify subsequent operations such as welding of current collector tabs.

The battery electrolyte may be comprised of a KOH solution or alternatively a NaOH based electrolyte. A preferred electrolyte comprises of NaOH, LiOH, and a sulfide additive such as Na₂S. In one embodiment, the electrolyte comprises 6M NaOH, 1M LiOH and 1 wt. % Na₂S.

The batteries, particularly including the continuous coated iron electrode, can be used, for example, in a cellphone, thereby requiring an electrode with only a single side coated. However, both sides are preferably coated, allowing the battery to be used in many applications as is known in the art.

The following examples are provided to further illustrate the present invention. They are solely meant to be illustrative, and not limiting.

### EXAMPLE

Two cells were constructed that had shims inserted into the cell case so that the pressure was less at the top of the electrode stack than at the bottom. The shims were each 3″ long and had a thickness of 0.27″ at one end and 0.41″ at the other. Two shims were inserted into the cell case so that the bottom inside the cell case was 0.28″ thinner than the top (e.g. a was 0.28″ smaller than b in FIG. 1). The cell was constructed using three negative and two positive electrodes, each of which were 2.75×1.75×0.025 in. The electrode stack alternated the positive and negative electrodes with two negative electrodes being placed on the outside. The positive electrodes were sintered nickel with nickel hydroxide active material. The negative electrode consisted of 16% nickel powder #255, 3.5% PVA, 80.1% iron (325 mesh), and 0.4% sulfur adhered to a perforated metal strip. The negative electrodes were wrapped with a polyolefin separator. The cells were filled with an electrolyte comprised of 6 M NaOH, 1 M LiOH, and 1 wt % Na₂S. The cells had a nominal capacity of 1.6 Ah.

### Comparative Example

Cells were constructed that had no shims inside the cell so that the space at top of the cell was the same as the bottom (e.g. a was equal to b in FIG. 1). The cell was constructed using three negative and two positive electrodes, each of which were 2.75×1.75×0.025 in. The electrode stack alternated the positive and negative electrodes with two negative electrodes being placed on the outside. The positive electrodes were sintered nickel with nickel hydroxide active material. The negative electrode consisted of 16% nickel powder #255, 3.5% PVA, 80.1% iron (325 mesh), and 0.4% sulfur adhered to a perforated metal strip. The negative electrodes were wrapped with a polyolefin separator. The cells were filled with an electrolyte consisting of 6 M NaOH, 1 M LiOH, and 1 wt % Na₂S. The cells had a nominal capacity of 1.6 Ah.

### Cell Cycling

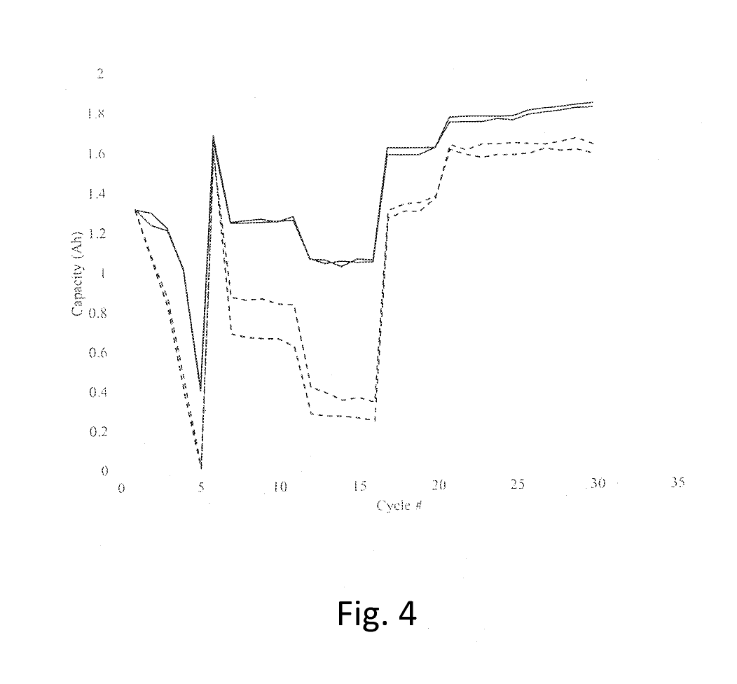

Following formation cycling all cells were charged at 0.8 A for three hours for all cycles. The voltage cut-off during discharge was 1.0 V for all cycles. The discharge rate was varied and the discharge currents following formation is shown in Table 1. The capacity versus cycle number is plotted in FIG. 4. The data clearly shows that cells with the beveled design clearly have improved capacity especially at high discharge currents.

TABLE 1

| # of cycles | Discharge current (A) |
|---|---|
| 1 | 0.32 |
| 1 | 0.80 |
| 1 | 1.6 |
| 1 | 3.2 |
| 1 | 8.0 |
| 5 | 1.6 |
| 5 | 3.2 |
| 4 | 0.4 |
| 10 | 0.16 |

While the foregoing written description of the invention enables one of ordinary skill to make and use what is considered presently to be the best mode thereof, those of ordinary skill will understand and appreciate the existence of various, combination, and equivalents of the specific embodiment, method, and examples therein. The invention should therefore not be limited by the above described embodiment, method and examples, but by all embodiments and methods within the scope and spirit of the inventions and the claims appended therein.

What is claimed is:

1. An alkaline battery comprising at least one positive electrode and at least one negative electrode with a separator disposed there between, which are contained in a cell casing that applies greater pressure to the electrodes towards the bottom of the electrode stack and less pressure towards the top of the electrode stack.

2. The battery of claim 1, wherein the battery comprises a KOH or NaOH electrolyte.

3. The battery of claim 2, wherein the battery comprises a NaOH electrolyte.

4. The battery of claim 3, wherein the NaOH electrolyte further comprises LiOH.

5. The battery of claim 4, wherein the electrolyte further comprises an alkali metal sulfide.

6. The battery of claim 5, wherein the electrolyte comprises 6M NaOH, 1M liOH and 1 wt % Na₂S.

7. The battery of claim 1, wherein the separator is comprised of a polyolefin.

8. The battery of claim 1, wherein the negative electrode comprises a single layer of a conductive substrate coated on at least one side with a coating comprising an iron active material and a binder.

9. The battery of claim 8, wherein the iron active material comprises an Fe metal or iron oxide species.

10. The battery of claim 1, wherein the positive electrode is comprised of a nickel or manganese material, and the negative electrode is comprised of an iron or zinc material.

11. The battery of claim 8, wherein the binder comprises polyvinyl alcohol.

12. The battery of claim 8, wherein the coating on at least one side comprises a sulfur, antimony, selenium, and tellurium additive, or mixture thereof.

13. The battery of claim 8, wherein the coating is on both sides of the substrate.

14. The battery of claim 8, wherein the substrate is a metal foil, metal sheet, metal foam, metal mesh, woven metal, or expanded metal.

15. The battery of claim 14, wherein the substrate is comprised of a nickel foam material.

16. The battery of claim 8, wherein the coating comprises a pore former.

17. The battery of claim 8, wherein the porosity of the electrode is in the range of about 30-50%.

18. The battery of claim 11, wherein the coating further comprises a sulfur additive.
